(19) United States
(12) Patent Application Publication
(10) Pub. No.: US 2006/0113122 A1
(43) Pub. Date: Jun. 1, 2006

(54) Push-stop bar unit and safety arrangement incorporating the same

(75) Inventor: Gert Persson, Lyckeby (SE)

Correspondence Address: WALTER OTTESEN, PO BOX 4026, GAITHERSBURG, MD, 20885-4026, US

(73) Assignee: Dynapac Compaction Equipment AB

(21) Appl. No.: 11/286,396

(22) Filed: Nov. 25, 2005

(30) Foreign Application Priority Data
Nov. 30, 2004 (SE) 0402901-3

(51) Int. Cl. B62D 51/04

(52) U.S. Cl. 180/19.1

(57) ABSTRACT

A push-stop bar unit (4) with legs (8) is included in a safety arrangement against crush for a self-propelled roller (1) controlled by an operator on foot. The push-stop bar unit (4) is pivotably connected via the legs (8) to the roller (1) controlled by an operator on foot. The legs (8) are made of plastic, rubber or composite materials.

### CROSS REFERENCE TO RELATED APPLICATION

This application claims priority of Swedish patent application no. 0402901-3, filed Nov. 30, 2004, the entire content of which is incorporated herein by reference.

### FIELD OF THE INVENTION

The present invention refers to a push-stop bar unit incorporated in a safety arrangement for a self-propelled roller or compaction apparatus controlled by an operator on foot. The safety arrangement is a “device against crush” which prevents the operator from becoming crushed by the roller. The push-stop bar unit is suitable for use with a safety arrangement to prevent injury in the context of heavy rollers controlled by an operator on foot, such as trench compactors.

### BACKGROUND OF THE INVENTION

Rollers controlled by an operator on foot can be operated with an operating rod. When the machine is reversed there is a risk of the operator failing to notice an obstacle to his or her rear and becoming crushed between the end of the rod and the obstacle. It is known that this type of machine can be fitted with a device against crush to prevent the operator from suffering injuries caused by crushing. The device against crush also incorporates a displaceable push-stop plate and push-stop rod which are operatively connected to equipment that can stop the reverse operation of the roller. The arrangement is described in the U.S. Pat. No. 4,573,543.

Certain rollers controlled by an operator on foot are used to compact the bottom and filling materials in trenches. These trench compactors are most often remote controlled, but with the capability for manual control. There are also trench compactors that can only be manually controlled. In the case of manual operation of trench compactors, the operator is positioned closer to the machine and runs the risk, in the manner described above, of becoming crushed along the full width of the machine. The device against crush must therefore incorporate a much wider design. It is known that the guard can therefore be designed instead as a U-shaped push-stop bar with the width of the machine and with the legs pivotably connected to the machine. The push-stop bar is arranged so that when it is exposed to pressure it pivots about the pivot connection and thereby activates a function that stops the reverse operation of the compactor.

The push-stop bar must be given an extension that allows the compactor to stop before it reaches the operator. The result of this is that the projecting push-stop bar become vulnerable during the loading and unloading of the machine. The push-stop bar can be arranged as retractable, but it is often the case that the operator forgets to enable the bar. An even more serious problem is the lateral loads generated when the push-stop bar collides with the walls of the trench when maneuvering the compactor down in the trench. The known push-stop bars made of steel can, to a certain extent, be dimensioned so that they can withstand these stresses. However, in this case, they tend to be unwieldy, since a trench compactor weighs approximately 1,800 kilograms. The frequent occurrence of heavy use often results in permanent deformation of the push-stop bar, which, in turn, leads to expensive stoppages.

### SUMMARY OF THE INVENTION

It is an object of the invention to provide a push-stop bar unit that retains its protective function, while also being flexible, and in this manner to prevent it from becoming permanently deformed during heavy use. This new characteristic is achieved by an innovative configuration of the legs of the push-stop bar unit. It is a further object of the invention to provide a safety arrangement having a push-stop bar that is flexible during overloading and thereby more durable during heavy use.

The push-stop bar unit of the invention is for a safety arrangement to prevent a crushing injury to an operator of a self-propelled compaction apparatus where the operator is on foot. The push-stop bar unit includes: first and second legs pivotally mounted on the apparatus so as to be pivotable about a pivot axis; a contact means disposed between the first and second legs for making contact with the operator thereby causing the push-stop bar unit to pivot about the pivot axis; and, the first and second legs comprising plastic, rubber or composite materials.

### BRIEF DESCRIPTION OF THE DRAWINGS

The invention will be described with reference to the drawings wherein:

FIG. 1 is a side elevation view of a roller controlled by an operator on foot with the roller being fitted with a push-stop bar unit according to the invention and shows the roller coming toward the operator;

FIG. 2 corresponds to FIG. 1 except that the operator is against the wall of the trench with the push-stop bar unit shown pushed down to cause the roller to come to standstill;

FIG. 3 is a schematic showing details of the safety arrangement of the invention;

FIG. 4 is a view from above the roller of FIGS. 1 and 2 showing the roller being maneuvered in a trench;

FIG. 5 is also a view from above and shows the push-stop bar unit in collision with a boulder projecting from the side wall of the trench; and,

FIG. 6 is a plan view of a push-stop bar unit according to the invention.

### DESCRIPTION OF THE PREFERRED EMBODIMENTS OF THE INVENTION

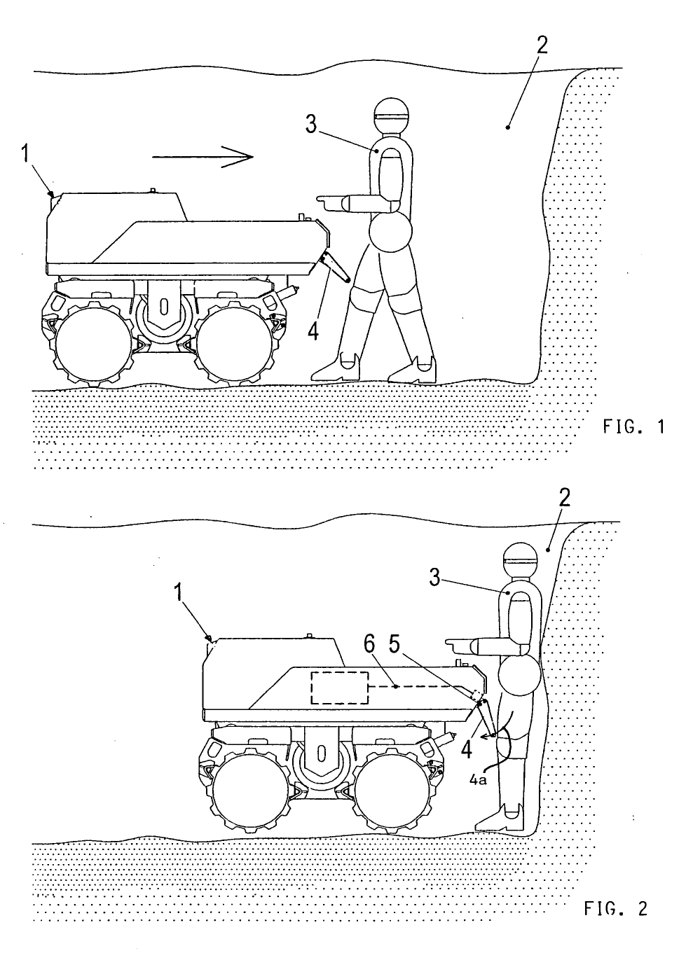

In FIGS. 1 and 2, a self-propelled roller controlled by an operator on foot is shown in operational use and is in the form of a trench compactor 1. Trench compactor 1 has vibrating drums equipped with pads and is used to compact the bottom of a trench 2. The trench compactor 1 is normally remote controlled by an operator standing on the edge of the trench 2. In FIGS. 1 and 2, the operator 3 is down in the trench 2 because he has decided to operate the trench compactor 1 manually.

In FIG. 1, the operator 3 has actuated the trench compactor 1 to move in reverse in the direction of the arrow and is walking backwards behind it. The trench compactor 1 is fitted with a push-stop bar unit 4 in accordance with the invention. The push-stop bar unit 4 shown here is in an enabled, non-actuated position.

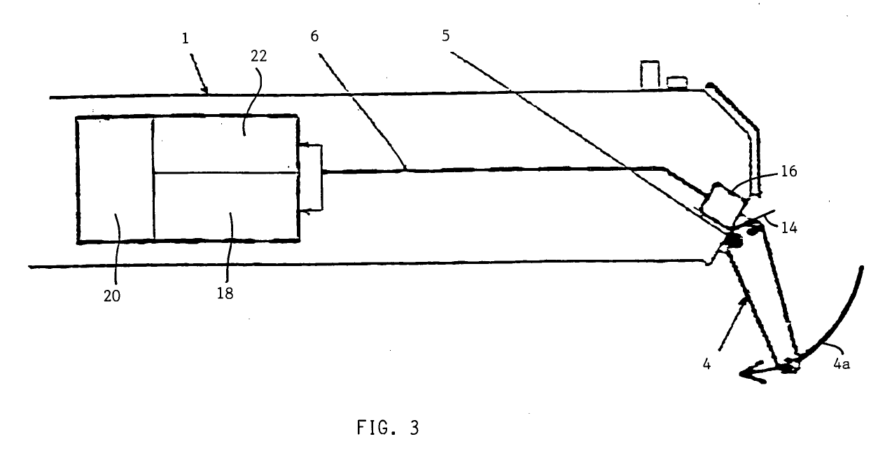

In FIG. 2, the backward movement of the operator 3 has been stopped by an obstacle, and he has not managed to actuate the trench compactor 1 to stop, or instead to move the trench compactor forward. The push-stop bar unit 4 has come up to the operator 3 and is then actuated to pivot about its pivot connection 5 on the trench compactor 1. The push-stop bar unit 4 is part of a safety arrangement 6 to prevent crush, which detects when the push-stop bar unit 4 is pivoted and stops the reverse operation of the trench compactor 1. The pivoting action of the push-stop bar unit 4 is indicated by arrow 4a and can, for example, be detected by a detector in the form of an inductive switch 16, which, via an electric signal, triggers a function in a control unit 18 or 22 (FIG. 3) that stops the reverse operation of the trench compactor, for example, by intervening in the hydraulic system of the trench compactor. It is also possible to use hydraulic sensors and signals, or a wire. The safety arrangement against crush 6 should be designed so that, when activated in accordance with the above sequence, it is still possible for the operator to actuate the compactor to forward operation.

FIG. 3 is a schematic of the safety arrangement of the invention which incorporates the push-stop bar unit 4 and reference is made to FIG. 3 to provide an explanation of how the pivoting action of the push-stop bar unit 4 is detected. When the push-stop bar unit 4 is actuated and pivoted about the pivot connection 5 in the direction of arrow 4a, a metal sheet 14 follows the pivot movement. An inductive switch 16 detects the angular displacement of the metal sheet and sends an electrical signal to the computer system 18 and also the electrical system 22. If the operator has chosen to operate the machine by remote control (radio control), the computer system 18 will immediately actuate the hydraulic system 20 to stop and block the operation of the compactor. If the operator has chosen to operate the machine manually, the electrical system 22 will replace the function of the computer system and stop and block operation of the trench compactor.

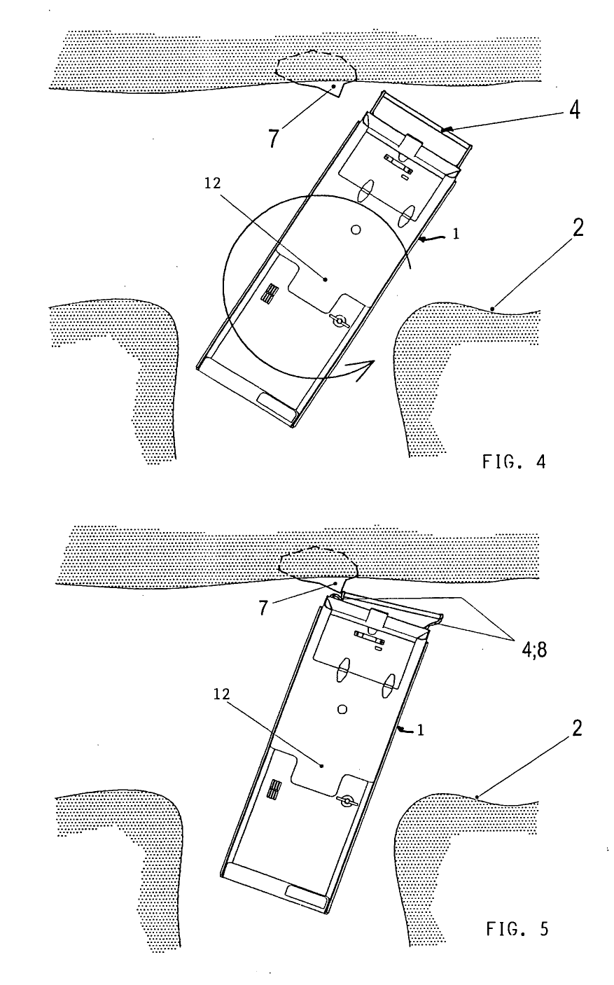

In FIGS. 4 and 5, the trench compactor 1 is shown from above in remote controlled operation in a trench. The operator (not shown) remote controls the trench compactor 1 from above on the edge of the trench 2.

In FIG. 4, the push-stop bar unit 4 can be seen in a non-actuated enabled position. For safety reasons the safety arrangement against crush 6 should be designed so that it is always enabled during operation of the trench compactor 1. The operator operates the trench compactor 1 by remote control to execute a turning maneuver in a T junction of the trench 2. The turning maneuver takes place about a point 12 in the middle of the trench compactor 1. The operator strives to achieve sufficient maneuvering space to avoid the trench compactor 1 colliding with the walls of the trench 2. An obstacle 7 in the form of a large boulder protrudes from the wall. Other projecting obstacles may be found in the trench in the form of pipe ends, the roots of trees and the ends of steel or concrete girders.

In FIG. 5, the operator did not notice the projecting obstacle 7 which has caused the push-stop bar unit 4 to collide with the projecting obstacle 7. The push-stop bar unit 4 has been struck in the horizontal plane which has resulted in the flexing response of its legs 8 in the desired manner and caused the push-stop bar unit 4 to give way to the projecting obstacle 7.

When the trench compactor 1 at a later stage is remote controlled to forward operation, the push-stop bar unit 4 will resume its original and functional configuration as shown in FIG. 4.

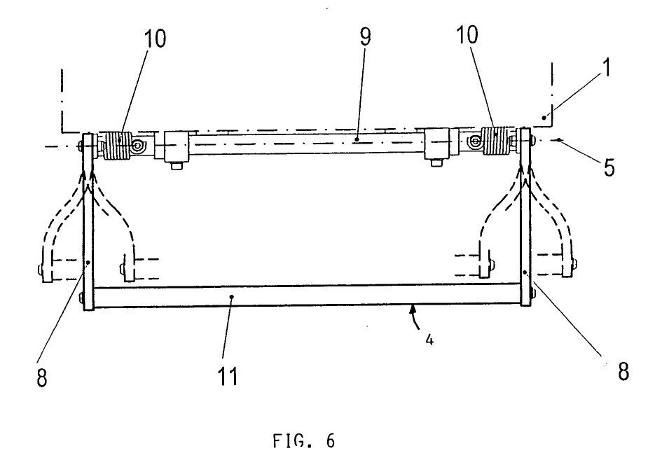

FIG. 6 shows the push-stop bar unit 4 from above. The push-stop bar unit 4 is pivotably connected via the legs 8 to the trench compactor 1 by a pivot connection 5. The pivot connection 5 can, for example, incorporate a tubular shaft 9 pivotably connected to the trench compactor 1. The tubular shaft 9 is resiliently biased in the enabled or active position shown in FIG. 1 by torsion springs 10. The tubular shaft 9 is held in a fixed active position by a stop (not shown) which limits the upward pivoting movement of the push-stop bar unit 4 to the position thereof shown in FIG. 1. The legs 8 of the push-stop bar unit 4 are connected to the tubular shaft 9 and the push-stop bar unit 4 is thus held in the enabled non-actuated position shown in FIG. 1.

The above-described design of the pivot connection 5 permits the push-stop bar unit 4 to be actuated in a pivot rotation downwardly. It is also possible to replace the above-mentioned stop with counteracting torsion springs. The push-stop bar unit 4 can then be actuated to rotate both upwardly and downwardly. The legs 8 of the push-stop bar unit 4 are connected to a contact part 11 in the form of a circular steel tube. The legs 8 of the push-stop bar unit 4 are made of a material having a greater elasticity than steel. The best solution is to use polyurethane, since this material has a greater elasticity, higher strength and good resistance to external environmental influences. It is also possible to use other plastic, rubber or composite materials with similar properties. The symmetric flexibility of the push-stop bar unit 4 when actuated from the side is shown in phantom outline in FIG. 6. This flexibility is, however, much greater than what is shown and can also act asymmetrically as previously shown in FIG. 5. To ensure that the push-stop bar unit 4 achieves the required function, the legs 8 have been designed with a significantly higher bending resistance in the vertical plane than in the horizontal plane. The vertical plane is in this context equivalent to an imaginary symmetry plane through the leg 8 and at right angles to an imaginary line through the pivot connection 5. The horizontal plane is an imaginary symmetry plane through the leg 8 and at right angles to the vertical plane. The higher bending resistance in the vertical plane ensures that the downward actuation of the push-stop bar unit 4 always results in a rotation about the pivot connection 5 so that the trench compactor 1 is brought to standstill. The lower bending resistance in the horizontal plane ensures that the push-stop bar unit 4 responds flexibly to lateral loads.

When loading and unloading the trench compactor 1, it can happen, for example, that the trench compactor is lifted down from a truck bed and placed so that the push-stop bar unit 4 ends up on an adjacent wall or the like. The push-stop bar unit 4 will then be actuated from below with considerable force, but can even in this case give way in that the legs 8 collapse out or in a manner that is difficult to predict. This flexible collapse is facilitated by the above mentioned differences in the bending resistance. When the trench compactor 1 is subsequently lifted or actuated to forward movement, the push-stop bar unit 4 will resume its functional configuration and position.

The push-stop bar unit 4 in the present invention can also function in a safety arrangement for both forward and backward operation, the number of push-stop bar units can be doubled and arranged both at the back and the front of the roller controlled by an operator on foot.

It is understood that the foregoing description is that of the preferred embodiments of the invention and that various changes and modifications may be made thereto without departing from the spirit and scope of the invention as defined in the appended claims.

What is claimed is:

1. A push-stop bar unit for a safety arrangement to prevent a crushing injury to an operator of a self-propelled compaction apparatus where the operator is on foot, the push-stop bar unit comprising:
first and second legs pivotally mounted on said apparatus so as to be pivotable about a pivot axis;
a contact means disposed between said first and second legs for making contact with the operator thereby causing said push-stop bar unit to pivot about said pivot axis; and,
said first and second legs comprising plastic, rubber or composite materials.

2. The push-stop bar unit of claim 1, wherein said first and second legs are made of polyurethane.

3. The push-stop bar unit of claim 1, wherein said first and second legs each have a first bending resistance in a horizontal plane; and, each of said first and second legs pivot in respective vertical planes and said first and second legs each have a second bending resistance in the vertical plane corresponding thereto greater than said first bending resistance.

4. A safety arrangement of a compacting apparatus operated by an operator while on foot, the safety arrangement being provided to protect the operator from a crushing injury by the compacting apparatus when the latter moves toward the operator and the operator is trapped between the oncoming compacting apparatus and a hard place, the safety arrangement comprising:
a push-stop bar unit including:
first and second legs pivotally mounted on said apparatus so as to be pivotable about a pivot axis;
a contact means disposed between said first and second legs for making contact with the operator thereby causing said push-stop bar unit to undergo a pivot movement about said pivot axis; and,
said first and second legs comprising plastic, rubber or composite materials; and,
the safety arrangement further including:
a detector for detecting said pivot movement of said push-stop bar unit and transmitting an electrical signal indicative of said pivot movement; and,
a control unit connected to said detector for receiving said electrical signal and to operate on the power system of said compacting apparatus to bring said compacting apparatus to standstill thereby preventing the operator from suffering a crushing injury.

5. The safety arrangement of claim 4, wherein said first and second legs are made of polyurethane.

6. The safety arrangement of claim 4, wherein said first and second legs each have a first bending resistance in a horizontal plane; and, each of said first and second legs pivot in respective vertical planes and said first and second legs each have a second bending resistance in the vertical plane corresponding thereto greater than said first bending resistance.
